(19) United States
(12) Patent Application Publication
(10) Pub. No.: US 2013/0207762 A1
(43) Pub. Date: Aug. 15, 2013

(54) CURRENT-COMPENSATED INDUCTOR WITH INCREASED LEAKAGE INDUCTANCE

(71) Applicants: Gerhard Karl, Breitenberg (DE); Herbert Maier, Passau (DE)

(72) Inventors: Gerhard Karl, Breitenberg (DE); Herbert Maier, Passau (DE)

(21) Appl. No.: 13/820,959

(22) PCT Filed: Sep. 6, 2011
(86) PCT No.: PCT/EP2011/004481

§ 371 Date: Apr. 10, 2013

(30) Foreign Application Priority Data
Sep. 7, 2010 (DE) 10 2010 040 326.1
Nov. 9, 2010 (DE) 10 2010 050 828.4

(51) Int. Cl. H01F 3/12

(52) U.S. Cl. CPC H01F 3/12
USPC 336/5

(57) ABSTRACT

Current compensated inductors have a substantially closed core, which deviates from the toroidal core design such that increased leakage flux is achieved and, at the same time, the further advantages of a conventional toroidal core geometry are maintained. In particular, the current-compensated inductors according to the invention can be produced efficiently by means of automation without subsequent process steps for fitting shunt elements being required.

This invention concerns general current-compensated inductors that are efficiently used for filtering out common-mode interferences and at the same time allow for a moderate suppression of differential-mode interferences caused by leakage inductance.

The operation of electronic devices also results in the production of a multitude of electrical interference signals, which are in part emitted and in part remain on corresponding lines; these may severely disrupt the operation of other electronic groups or other circuit areas of the electronic device causing the disruption. For example, the supply lines of electronic assembly units are frequently impacted with interference signals, which can lead to the production of additional interference signals in the further electronic components, such as in the adjustment of internal supply voltages, etc. In addition, the presence of strong interference signals in a supply line can also lead to a significant reduction in efficiency in downstream circuits, such as in switching power supplies, electric drives, etc. Interference signals that frequently arise include so-called “common-mode interference signals”, which arise on feed lines of the supply voltage in a nearly identical manner. Such common-mode interference signals may be efficiently reduced by using so-called “current-compensated inductors”, in which two identically wound windings, i.e. for a 2-phase system, are applied on a core and have opposing interconnections. This arrangement results in nearly no magnetic field in the common core, induced by the active current through the respective windings, since the effects of the opposingly provided windings provide complete compensation for this. That is, the selected inductance of the current-compensated inductor, which is usually high, is almost ineffective for the useful signal. On the other hand, an additive effect of the two windings with opposing interconnections arises upon the appearance of a common-mode interference signal, such that, in this case, the total inductance of the current-compensated inductor is effective and will thus achieve an effective suppression of interference signals. Thus, other components can be provided in the form of capacitors and the like.

Such current-compensated inductors are frequently used in signal lines, in order to likewise suppress common-mode interference signals in such lines in an efficient manner. For this purpose, a wide variety of current-compensated inductors was developed; these enable an efficient suppression of common-mode interferences, but without impairing the bandwidth necessary for the useful signal in an unnecessary manner. In particular, highly efficient current-compensated inductors are produced on the basis of toroidal cores, in which the windings are typically applied in a symmetrical manner on the toroidal core, such that a highly symmetrical design, in combination with the favourable scattering properties of the toroidal core, leads to a strong suppression of common-mode interference signals. In the production of such current-compensated inductors under the application of toroidal cores, it is typical that automated winding procedures are used, in which the toroidal core is wound directly with a correspondingly suitable wire, without using a coil bobbin, provided that the necessary insulation and leakage current routes can be maintained.

However, in many filter applications, suppressing common-mode interference signals in a manner as efficient as possible is not the only aspect to be considered. For example, for many filter applications, a higher level of leakage inductance, which ultimately has an effect on the useful signal, is desirable in a higher degree, in order to likewise reduce to a certain degree the differential-mode interference signals that interfere with the useful signal. That is, in such filter applications, there is generally a selection of a configuration in which a higher degree of leakage inductance is achieved, such that, in addition to an efficient suppression of common-mode interference signals, a suppression of the differential-mode interference signals is also possible. For this purpose, for example, additional longitudinal inductors or, in some conventional applications, E-cores with as many turns as possible are used, which thereby have a higher degree of leakage inductance compared to toroidal cores, thus approaching the desired behaviour with regard to a moderately high level of leakage inductance. In other approaches, an additional shunt element is added at a suitable location to conventional cores, such as E-cores or even toroidal cores, such that a higher level of leakage inductance arises. For example, for a closed core, such as a toroidal core, the shunt element may be inserted at a portion between the windings in form of a magnetic core with specific properties, such that a higher level of leakage inductance can be selectively adjusted depending on the magnetic properties. However, the provision of corresponding shunt elements, for example in the form of rods, requires additional manufacturing steps, such as adhering the shunt element to a given core after application of the winding, and the like, resulting in significantly increased production costs. In addition, such additional manufacturing steps can lead to a greater variability in the resulting properties of the current-compensated inductors, as already minimal deviations in the air gap between the actual core and the shunt element exert a great influence on the obtained leakage inductance and on the tune-ability of the current-compensated inductor. In particular, for toroidal core geometries, there are additional complex manufacturing steps upon installing a shunt element, since, for example, an automated winding of the toroidal element is not compatible with the presence of a shunt element, such that the shunt element can only be applied in subsequent process steps, or the inductor has to be produced by intricate manual labour, resulting in the aforementioned limitations in terms of reproducibility and accuracy.

Considering the above factual situation, it is an object of the present invention to provide a current-compensated inductor with a moderately high leakage inductance and lower variability in the component properties.

In accordance with an aspect of the invention, the above object is solved by a current-compensated inductor having a core with a first curved winding portion, a second curved winding portion and a leakage inductance portion disposed between the first and the second winding portion. The leakage inductance portion connects the first winding portion and the second winding portion, so as to define a total length of the core. Furthermore, the current-compensated inductor has a maximum core width that is smaller than the total length of the core. The current-compensated inductor further comprises a first winding that is disposed on the first curved winding portion, and a second winding that is disposed on the second curved winding portion.

Generally, by means of this configuration of the current-compensated inductor in accordance with the invention, a special geometry is provided, particularly for 2-phase systems, enabling a leakage inductance to be precisely adjusted. For this purpose, the core, which at least in the winding portions reproduces the shape of a toroidal core with its advantageous properties with regard to guiding the magnetic field, has a leakage inductance portion which decisively determines the total length of the magnetic core. On the other hand, the geometry of the core is defined such that a maximum width is smaller than the total length of the core, such that, as a whole, an “oval” or stretched form arises, thus contributing to a higher level of leakage inductance within the leakage inductance portion. That is, on the basis of the curved winding portions, a very low-scattering configuration is achieved in this part of the core, such that the leakage inductance portion substantially contributes to the leakage inductance a controlled manner within the leakage inductance portion, the substantial contribution being therefore adjustable in an easily reproducible manner on the basis of the structural characteristics of the core.

In this regard it is noted that a total length of the core is to be understood as a geometrical dimension of the core material and differs from a magnetic length of the core. In this application, with regard to the magnetic properties, such as with regard to the length, the reference is always made to a magnetic length, while without any additional reference, the descriptions of “length”, total length and the like always refer to geometric dimensions of the core material. In a similar manner, a width of the core is understood as the maximum dimensions of outer edges of the core material along a direction perpendicular to the longitudinal direction of the core, while an internal width designates a corresponding spacing of core materials in the width direction at a certain position.

In an additional advantageous embodiment, the leakage inductance portion between the first winding portion and second winding portion has a constant width. In such a case, a simple geometrical configuration thus arises, since an “oval” configuration arises in conjunction with the curved winding portions, wherein, in this embodiment, the leakage inductance portion is provided as a straight-line portion, at least on the outer edge. The simple geometry of the core thus leads to a total leakage inductance which may be efficiently controlled and which may be efficiently adjusted for many types of current-compensated inductors, for example, by accordingly adjusting the length of the linear leakage inductance portion for otherwise like parameters.

In an additional advantageous embodiment, the width of the leakage inductance portion, thus the width defined by the two legs of the leakage inductance portion, is, at least in places between the first and the second winding portion, smaller than the maximum core width. On the basis of this geometric configuration of the leakage inductance portion, such as with one of a constant and smaller and larger cross-section of the core, there can be a narrowing and thus convergence of opposing portions and/or legs of the leakage inductance portion may occur by structural measures, such that the magnitude of the leakage inductance may be adjusted by means of the geometry, without, for instance, the necessity to increase the total length of the core. That is, the leakage inductance can be efficiently predefined by means of the structurally adjusted minimum width between the opposing portions and/or legs of the leakage inductance portion, while, however, maintaining a relatively large spacing, such that efficient automated winding processes can be applied.

In an additional advantageous embodiment, the width of the leakage inductance portion comprises at least two positions with minimum width. In this manner, with given external dimensions, the leakage inductance may be predefined in a highly precise manner for different types of inductors, without impairing the automatic winding capability. Furthermore, by means of a corresponding design of the leakage inductance portion, an efficient delineation to the winding areas can be achieved, such that well-defined geometric winding lengths can be generated in the winding portions, which accordingly contribute to an improved symmetrical structure of the inductor.

In an additional advantageous embodiment, the core comprises curved sections. In this manner, any sharp edges in the core material, which would otherwise contribute to a poorly controllable leakage inductance behavior, can be avoided. Providing the curved sections, that is, avoiding any edges, also leads to a better behavior in the mechanical production of the current-compensated inductor, as the risk of material chippings and the like is significantly reduced.

In an illustrative embodiment, a minimum internal width between opposing portions and/or legs of the leakage inductance portion is larger than approximately 50% of a maximum internal width of the core. An according geometric configuration of the core, on the one hand, allows for a desired high level of leakage inductance by means of reducing the width of the opposing portions of the leakage inductance portion, while, on the other hand, a sufficient spacing is preserved in the interior of the core, such that no malfunction is caused by downstream production steps, such as the automated winding of the winding portions.

In an additional embodiment, the current-compensated inductor comprises a support or a housing that is connected to the core by means of clamping. For example, the leakage inductance portion, which does not carry any windings, can be efficiently used for this purpose, by, for example, enganging clamping hooks of the housing in a suitable manner with the core. Preferably, the housing and the leakage inductance portion are accordingly formed such that a corresponding clamping device can be reliably and reproducibly brought into engagement with the core. This clamping, without any additional adhering or sealing compound, also naturally contributes to the protection of resources, and thus to environmental protection.

An additional advantage is that, for embodiments concerning SMD applications, the middle centering area in the support or housing may be used for suction.

In accordance with an additional aspect of this invention, the aforementioned object is solved by means of a current-compensated inductor comprising a core built having curved portions. Winding portions that oppose each other in the longitudinal direction of the core and a leakage inductance portion disposed in a longitudinal direction between the winding portions are provided, wherein the core assumes its maximum internal width outside of the center of the leakage inductance area. Furthermore, the current-compensated inductor comprises windings that are correspondingly disposed on the winding areas.

In this embodiment, the core generally formed from curved portions which generally allow for a structure with low inductance, wherein, on the basis of the reduced internal width of the leakage inductance portion, the desired leakage inductance is then adjusted by means of structural measures. That is, a portion having a leakage inductance that may be deliberately adjusted to a desired value is provided in the core structure that otherwise has low inductance by means of a well-defined structural limitation.

In an additional embodiment, the internal width at the center of the leakage inductance portion is smaller than a maximum internal width of the core. That is, in this embodiment, a narrowing of the core actually arises within the leakage inductance portion such that the leakage flux is further increased.

In an additional advantageous embodiment, a minimum internal width in the leakage inductance portion is larger than or equal to 50% of a maximum internal width of the core. A high level of leakage inductance also arises in this embodiment, yet the resulting minimum internal width enables an automatic winding of the core.

In some embodiments, the leakage inductance portion is provided with at least two positions of locally minimal internal width.

In an additional embodiment, the core is provided without an air gap such that a “closed” core configuration arises as a whole, while the internal area enclosed by the core material is nevertheless sufficiently dimensioned such that an automated winding is possible. On the other hand, the gap-free structure of the core enables the use of any well-established magnetic materials, as they are typically used for toroidal cores.

In an illustrative embodiment, the total length of the core is 20 mm or smaller such that the inductor can be provided for corresponding applications, in which, for example, inductance values of up to 100 millihenrys at active currents of several amperes may be necessary, wherein, despite the highly compact dimensions of the core, the desired moderately high level of leakage inductance is achieved with good reproducibility; nevertheless, the windings can be applied in an automated manner.

In additional illustrative embodiments, the inductor is designed for an operating current of 20 amperes or higher; that is, the current-compensated inductor according to the invention may also be efficiently provided for filter applications in power components, in which currents of a multiple of 10 amperes, up to some 100 amperes or higher, are to be filtered with regard to common-mode and differential-mode interference signals. Thus, the corresponding cores can be provided with a well-defined geometry such that, also in this case, the leakage inductance is, with a high degree of accuracy, adjustable by means of the geometry of the core in the manufacturing of the core, without having to subsequently install additional shunt elements.

In accordance with an additional aspect of the present invention, the aforementioned object is solved by means of a magnetic core, which is may be used for current-compensated inductors. The magnetic core comprises a plurality of curved portions, each of which has a first distance from a common center. Furthermore, the magnetic core includes a plurality of connecting portions, of which connecting two or more of the plurality of curved portions, wherein the plurality of connecting portions each have a second distance from the common center and the second distance is different from the first distance.

Thus, the magnetic core for current-compensated inductors according to the invention comprises a form deviating from the form of a toroidal core such that, by means of the different distances of the respective portions of the core, the leakage inductance behavior can be accordingly adjusted. The magnetic core according to the invention is suitable for two-phase current systems and also particularly for multiple-phase systems, for instance for a three-phase current system, wherein the particular curved portions, in combination with the connecting portions, enable a configuration that is highly symmetrical for the particular phases, and nevertheless achieves a desired high level of leakage inductance due to the different distances.

In an advantageous embodiment, three curved and three associated connecting portions are correspondingly provided in view of a three-phase system such that, as a whole, a toroidal-like core configuration is achieved, wherein, however, based on the different distances of the curved portions and connecting portions given the core design, selective “bottlenecks” are produced in the core, which, on the one hand, enable well-defined leakage inductance values and, on the other hand, also result in well-defined winding portions for the multiple-phase windings to be applied.

In an advantageous embodiment, the second distance, i.e., the distance of the connecting portions, is smaller than the first distance. Thus, in particular, the curved portions are generally provided with a larger distance such that these portions are preferably provided as winding areas, whereas the connecting portions serve as efficient leakage inductance portions, as they have a smaller distance to the center and also to furhter core portions.

In an illustrative embodiment, each of the connecting portions has a straight-line section, while, in other illustrative embodiments, the connecting portions are also implemented as curved portions. Thus, a very high degree of flexibility arises in the adjustment of the total magnetic length of the core, since, for instance by means of the provision of straight-line sections in the connecting portions, an adjustable total magnetic length is, as a whole, achieved, whereas a formation as an curved portion in the connecting portions contributes to a larger total magnetic length with the same geometric “length”.

The curved portions and connecting portions can have an identical cross-section, such that the magnetic cross-section area is substantially the same across the total magnetic core. In other illustrative embodiments, the cross-section is variably designed, at least in sections, in the curved portions and/or in the connecting portions, with regard to form and/or an area of the cross-section, in order to thereby specifically take magnetic requirements into account, for instance in the form of providing protrusions or the like, such that the leakage inductance can be increased locally. Furthermore, an enlargement of the core cross-section at certain positions can be advantageously exploited, in order to, for instance, increase mechanical stability and/or provide specially designed core portions, which enable an advantageous mechanical fixing with regard to the application of windings, as described, for example, with regard to the current-compensated inductors as presented above.

In accordance with an additional aspect of this invention, the aforementioned object is solved by means of a current-compensated inductor, which in particular comprises the aforementioned magnetic core. In this manner, current-compensated inductors can be particularly provided for multiple-phase systems, such as three-phase systems, wherein the previously mentioned advantages in terms of machine-capable treatment arise, in particular for the application of the respective windings. For example, each winding can be advantageously applied in a machine-capable manner on one curved portion, while the non-wound connecting portions then efficiently serve as leakage inductance areas, as previously described. Thus, it is possible to provide a highly symmetrical adjusted and increased leakage inductance for three-phase or multiple-phase systems, such that a highly efficient suppression of common-mode and differential-mode interference signals arises.

Additional advantageous embodiments can also be found in the dependent claims of the attached patent claims and the following detailed description. The following detailed description refers to the sliding drawings, in which:

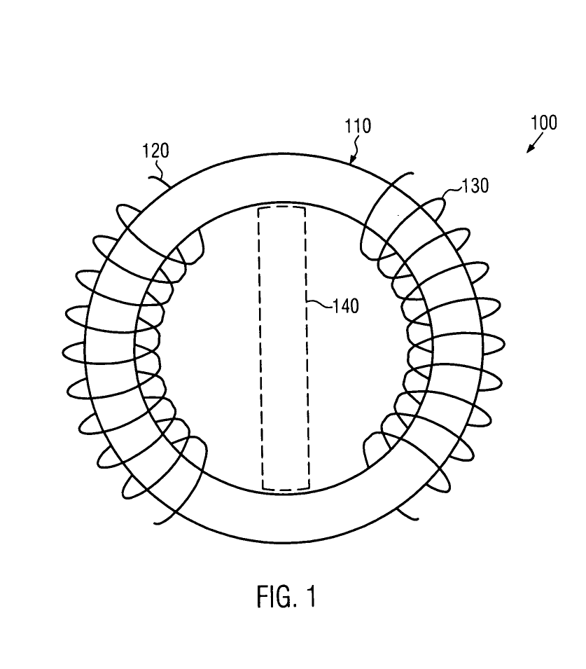

FIG. 1 schematically shows a current-compensated inductor in accordance with a conventional design as a comparative example,

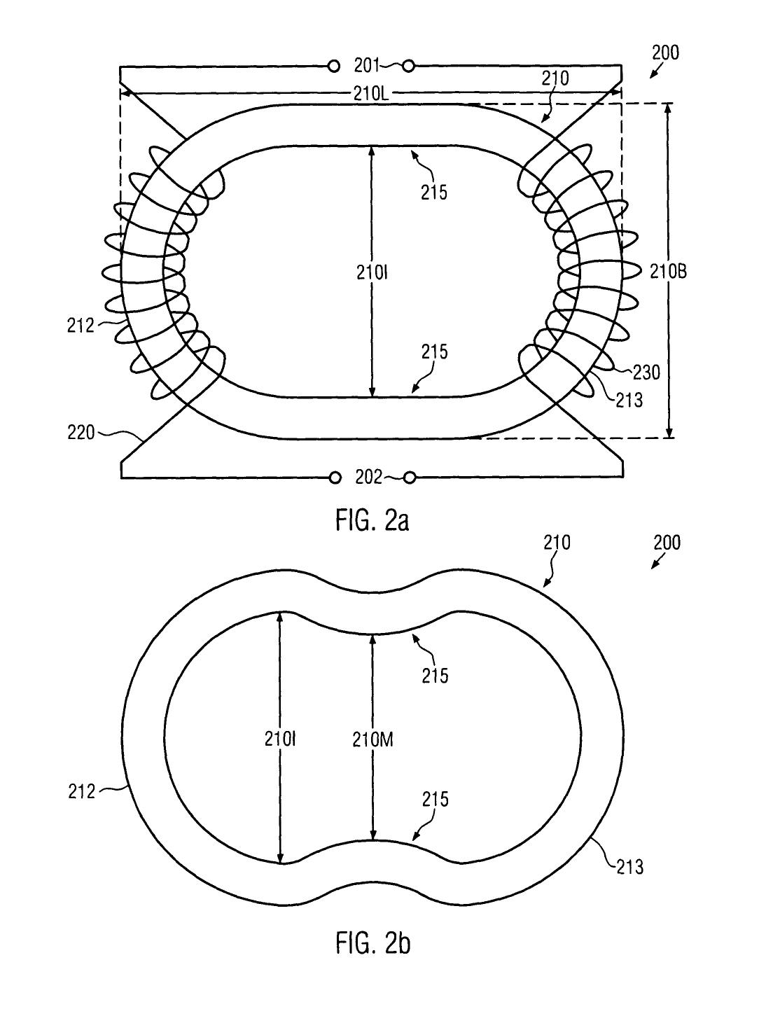

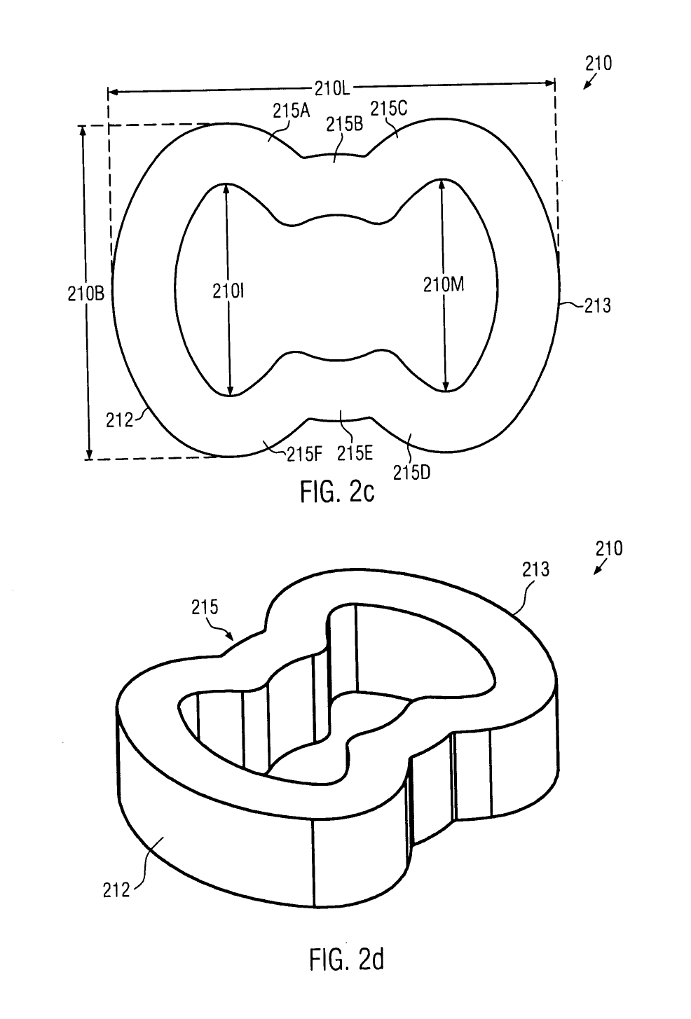

FIG. 2a schematically shows the top view of a current-compensated inductor, in which a general “oval” design results in a leakage inductance portion, which gives rise to a moderately high level of leakage inductance, which is determined by the geometry of the core,

FIG. 2b schematically shows a top view of a core , in which a suitable “necking” is provided in a closed core in the form of a leakage inductance portion,

FIG. 2c schematically shows a top view of a core of the current-compensated inductor, wherein the core is formed from curved portions, and the leakage inductance poriton has two minimum spacings for the adjustment of the desired leakage inductance and an efficient limiting of a suitable winding space,

FIG. 2d shows a schematic perspective view of the core from FIG. 2c,

FIG. 2e schematically shows a top view of the current-compensated inductor with a support,

FIG. 2f schematically shows a cross-sectional view along the section IIf in FIG. 2e,

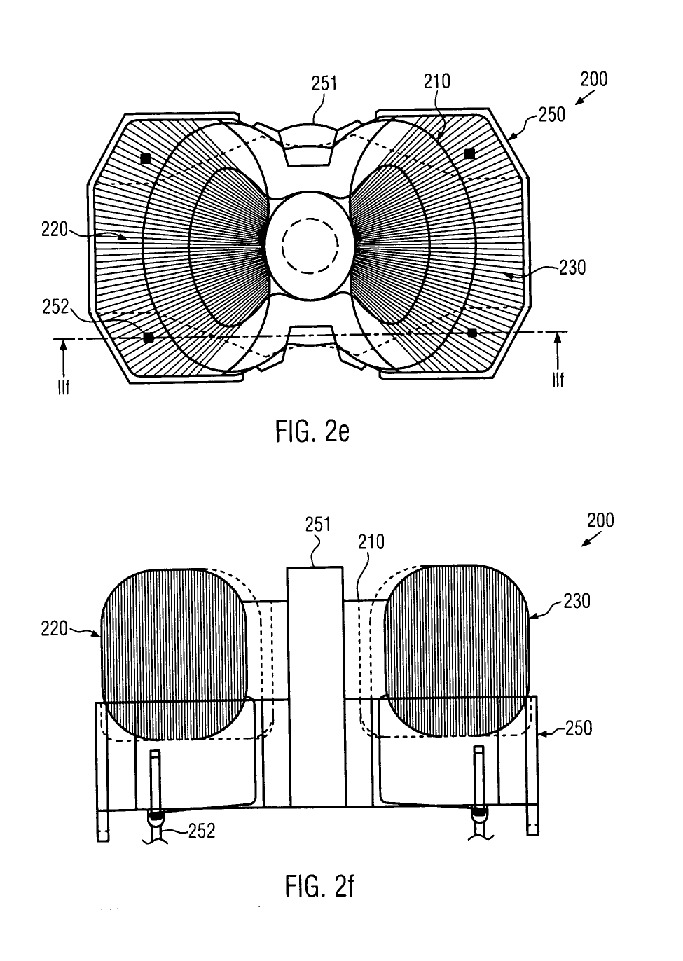

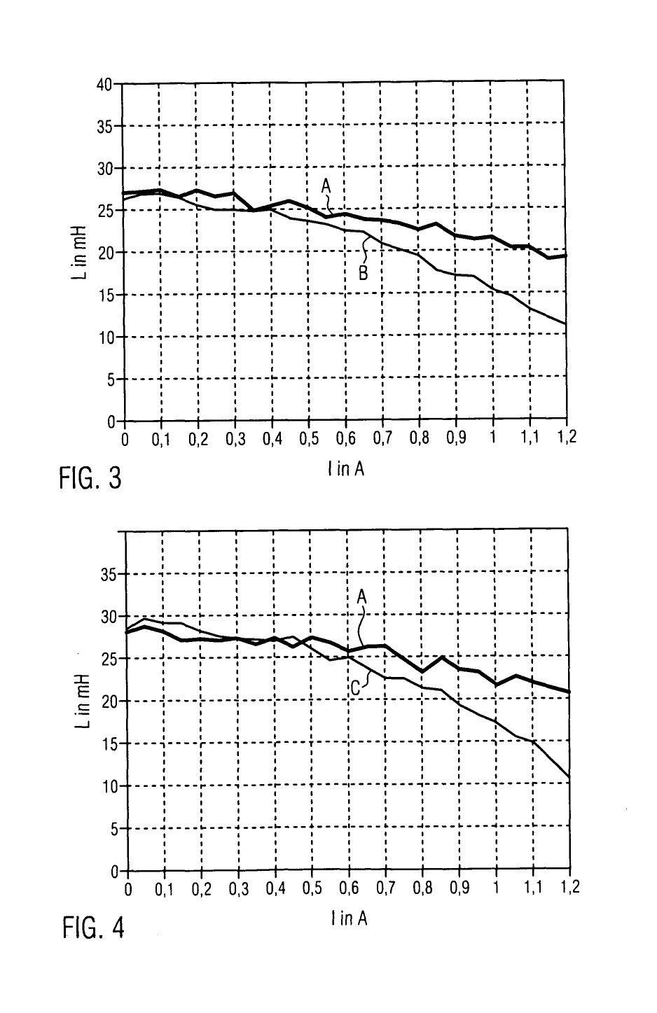

FIG. 3 schematically shows the dependency of the inductance of the current-compensated inductor of the comparative example from FIG. 1 on the current,

FIG. 4 shows the dependence of the inductance on the operating current, wherein a core geometry according to FIG. 2a is represented in comparison with a toroidal core geometry in FIG. 1,

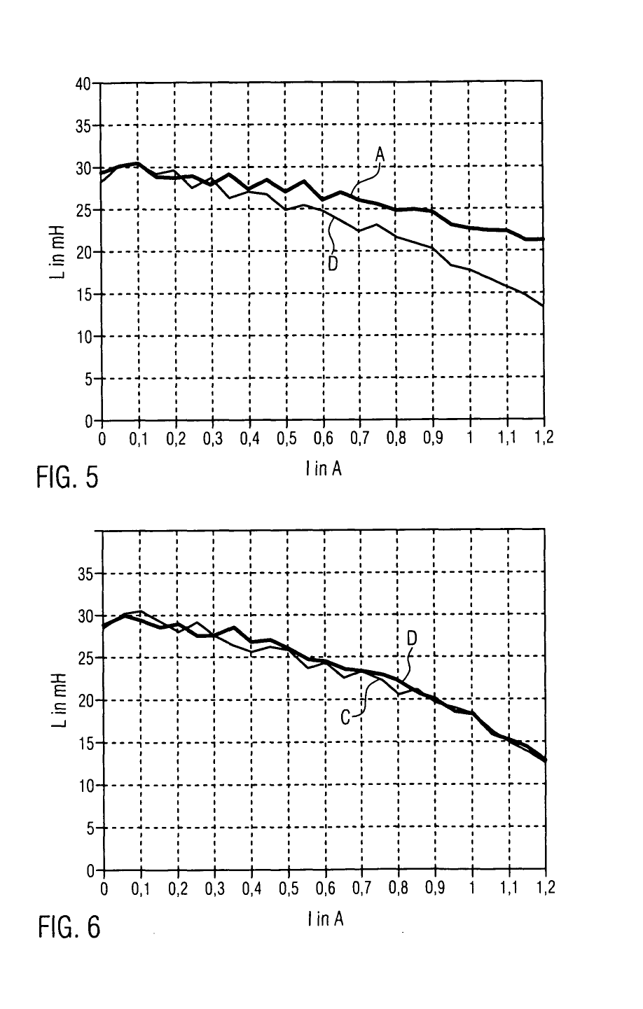

FIG. 5 illustrates the current dependence of the current-compensated inductor for the core shape shown in FIGS. 2c and 2d, in comparison with the toroidal core in FIG. 1,

FIG. 6 shows a comparison of the dependency of the inductance on the operating current for various core shapes in accordance with the present invention,

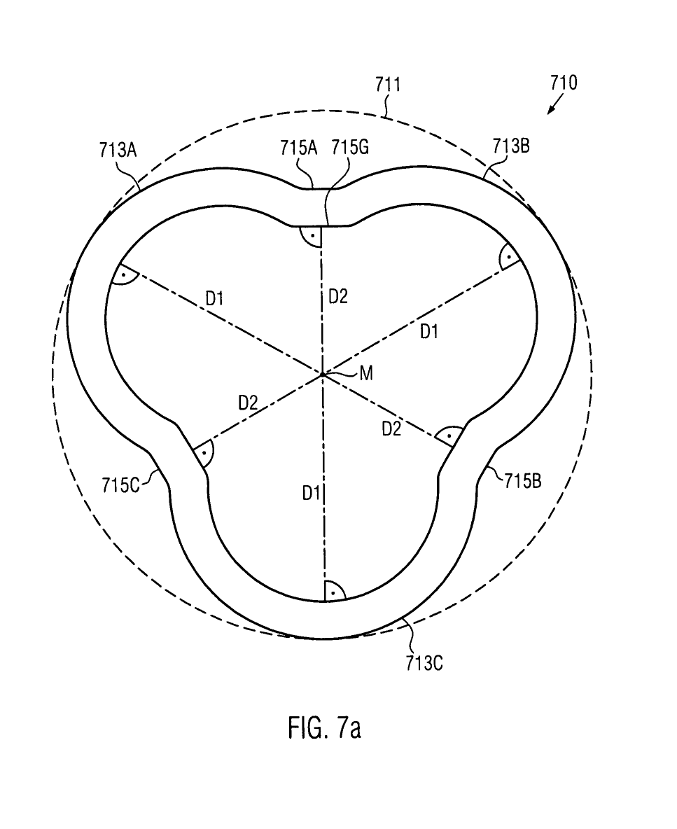

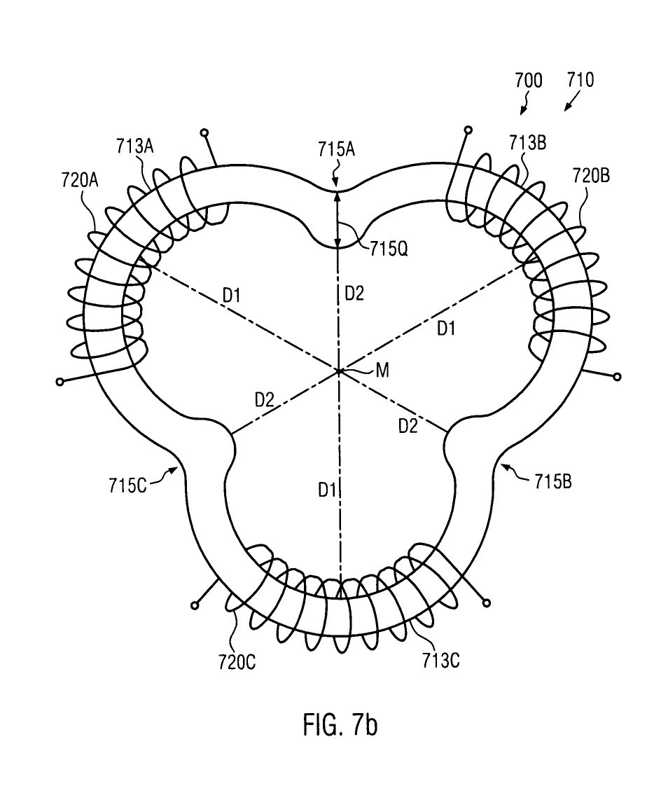

FIG. 7a schematically shows a top view of a magnetic core with a design deviating from the toroidal core, which is designed for multiple-phase systems, wherein, in the embodiment shown, the core for a current-compensated winding arrangement is provided for a 3-phase system, and

FIG. 7b shows a schematic view of a current-compensated inductor for a 3-phase system, thus with the windings.

With reference to the accompanying drawings, additional embodiments are now described in detail, wherein, for comparison purposes with reference to FIG. 1, the structure of conventional current-compensated inductor is represented with toroidal core geometry.

FIG. 1 schematically shows a top view of a current-compensated inductor 100, which comprises a toroidal core 110, on which a first winding 120 and a second winding 130 are disposed in a symmetrical manner such that, upon a symmetrically geometric design of the arrangement and, based on the known manner of favorable properties of the core 110 with regard to leakage inductance, a higher desired degree of compensation of common-mode interference signals is achieved, as this was already described. That is, the windings 120 and 130 are, in reference to the core 110, mounted at opposing positions and have the same number of turns, wherein there is usually the attempt to establish additional characteristic of the windings, such as distances between individual turns and the like, as symmetrical as possible for both windings. For this purpose, automatic winding processes, in which suitable isolated conductor materials are disposed on the core 110, are typically used.

The magnetic core 110 is thereby formed by any suitable core material, such as highly-permeable ferrite materials and the like, which are selected according to the desired inductance values and applications. As initially mentioned, a higher level of leakage inductance of the inductor is required for many applications, such as to effectively suppress common-mode interference signals; which is typically accomplished by means of the provision of a shunt element 140, for instance in the form of a ferrite rod or the like. For this purpose, after the windings 120, 130 being disposed, the ferrite rod 140 is attached to the core by, for instance, adhesives, wherein, in cooperation with the general properties of the element 140, that is, its magnetic length, its magnetic cross-section, to a lesser extent the permeability of the magnetic material, in particular the resulting air gap between the core 110 and the element 140 determines the course of the field lines in the element 140. For example, if required, the leakage inductance, which for the current-compensated inductor 100 is of a value of around 0.5 to 1.0% of the target inductance of inductor 100, can be increased by 50 to 100% by means of the provision of the shunt element 140, if required. That is, an efficient compensation of differential-mode interference signals, without significantly impairing the useful signal components, is achieved in this manner.

In contrast, in accordance with the invention, the desired high leakage inductance is achieved by means of structural measures, i.e. through the geometric design of the core, without having to provide additional components of the core, such as in the form of a shunt element, after the winding. For this purpose, the core shape according to the invention is designed in such a manner that suitable windings portions, which enable a machine-capable winding, are also provided for a closed core shape, while other non-wound portions bring about an increase in the leakage flux, wherein the increase is specified through the geometry of the core in this portion. For this purpose, in some descriptive embodiments, a general “oval” model for a closed core geometry is selected, such that the windings on opposing portions of the “oval” core are disposed with a maximum distance to each other, while the accordingly non-wound portions of the core, compared to the maximum length, have a smaller distance, referred to hereinafter as width, such that an increased leakage flux arises from the “proximity” to the non-wound portions. Generally, by means of the present core shape, a low-induction structure is possible at the windings, while on the other hand the leakage flux is selectively increased in the non-wound portion, referred to hereinafter as the leakage inductance portion, as compared to a normal toroidal core geometry. In doing so, when compared to a pure toroidal core geometry, an additional shunt element can be omitted, yet without, as a whole, substantially changing the structural dimensions of otherwise specified characteristics of the current-compensated inductor.

With reference to FIGS. 2 to 7, additional descriptive embodiments are now described in detail, wherein, if necessary, reference is also made to the comparative example in FIG. 1.

FIG. 2a schematically shows a top view of a current-compensated inductor 200 having a core with an increased leakage flux area, wherein, for the sake of simplicity, such a core shape is referred to hereinafter as an “oval” core shape. In the example shown, the core 210 is a closed core, i.e. a core without an air gap, wherein the magnetic length, the magnetic cross-section, the permeability of the material that is used, and the like, are adjusted in a suitable manner to the desired characteristics of the inductor 200. In this regard, it is pointed out that for the material of the core 210 and processes for the manufacturing of the core 210, respective techniques are to be employed, as they are also used for ordinary toroidal core geometries. The core 210 is characterized by a total length 210L, which arises as a maximum dimension of the outer edges of the core 210, wherein the longitudinal direction is understood as the extension of a first winding 220 to a second winding 230. That is, the longitudinal direction and thus the total length 210L of the core 210 is determined through the maximum distance between a first winding portions 212 and a second winding portion 213, on which the windings 220 and 230 are correspondingly disposed. It should be noted that, consistently in this application, the term “longitudinal direction”, and thus the total length of the core, is understood in the previously defined sense. On the other hand, a width 210B of the core 210 is understood by the maximum dimension of the core 210 in a direction perpendicular to the longitudinal direction, i.e. perpendicular to the total length 2101. Within the meaning of this application, an “oval” core shape is accordingly understood as a core shape in which the total length 210L is larger than the maximum width 210b, independent of the geometrical form of a portion 215 of the core 210 provided between the winding portions 212 and 213, which is referred to hereinafter as the leakage inductance portion. In the embodiment shown, the winding portions 212, 213 are curved sections, such that the advantageous behavior of the toroidal core geometries arise in these portions, while the leakage inductance portion 215 in the example shown essentially exists as a straight-line portion such that, for example, the width 210B is nearly constant in the longitudinal direction along the leakage inductance portion 215.

The core 210 also has an internal width 210I, which in this application is understood as a dimension along the width direction, which is provided by inner edges of the core material 210. Herein, the maximum value is understood as the internal width 210I, which maximum value arises from portions of the core 210 that oppose each other along the total length 210L. In the example shown, with the straight-line leakage inductance portion 215, the core 210 thus assumes its (maximum) inner width along the portion 215 and thus outside of the center 215M of the portion 215.

The current-compensated inductor 200 can be produced on the basis of established manufacturing procedures, by bringing the core 210 into the desired oval form by means of suitable materials, for example by pressing suitable shapes by means of processes that are also used for ordinary toroidal cores. In addition, due to the geometry of the core 210, the core 210 can be wound by machine, in order to, for instance, dispose the windings 220, 230 with the desired properties. On the other hand, the leakage flow properties of the core 210, in combination with the windings 220, 230, are constructively provided by means of the geometry of the core 210 and, in particular, by means of the leakage inductance portion 215. In further processing steps, the structure formed by the core 210 and the windings 220, 230 can be mounted on a support or incorporated into a suitable housing, as this is also described in greater detail below.

When operating the power-compensated inductor 200, a useful signal to the terminal points 201 is created, and this can be tapped on ports 202, wherein an efficient suppression of common-mode interference signals takes place based on the symmetric structure of the component 200, while the suppression of differential-mode interference signals takes place on the basis of the current leakage inductance, without unduly impairing the useful signal, as previously described.

FIG. 2b schematically shows a top view of the component 200, wherein the core 210 has a modified “oval” core shape compared to FIG. 2a. As shown, the internal distance and the internal width, respectively, at the center of the leakage inductance portion 215, as indicated by 210M, amounts to a value that is lower than the internal width 2101 such that a corresponding narrowing is caused by the geometry of the core 210. In the embodiment shown, a relatively constant magnetic cross-section is provided for the core material such that the reduced width 210M at the center of portion 215 efficiently leads to an increase in the leakage flux. However, it should be noted that, in accordance with other embodiments, the cross-section of the core 210 may vary at about the portion 215, as presented, for instance, in case of an enlargened cross-section by the dashed line 215Q. In other embodiments, the cross-section may be smaller than in the winding portions 212 and 213, or the cross-section of the portion 215 may be increased or reduces as compared to the portions 212 and 213. It should also be noted that the narrowing, which is indicated by the width 210M, is adjustable in accordance with the requirements, but is selected in such a manner that a mechanical winding of the winding portions 212 and 213 continues to be possible. For this purpose, the size of the minimum width 210M in some descriptive embodiments is limited to a maximum 50% of the internal width 210I. In this manner, it is ensured that there is a sufficient mechanical accessibility of the space enclosed by the core 210 when mechanically winding the core 210. In other embodiments, the narrowing may be more pronounced; thus, the minimum width 210M may be lower than 50% of the internal width 210I.

FIG. 2c schematically shows a top view of the core 210 in accordance with additional descriptive embodiments, in which the core 210 is formed from a plurality of curved sections. As shown, the winding portion 212 is provided as an curved section 210, which is determined by a specific curvature radius for a given cross-section of the core 210. In the same manner, the winding portion 213 is provided as a curved section. Corresponding curved sections of the leakage inductance portion 215 are connected thereto, wherein the various sections are provided with corresponding curvature radii in order to thus receive the desired overall core shape. In the example shown, curved sections 215a, 215b, 215c, which form a part and/or leg of the portion 215, and sections 215d, 215e, 215f, which form an opposing part and/or leg of the portion 215, are shown, and thus connect the winding portions 212 and 213. In the illustrated embodiment, two places with minimal internal width 210M arise based on varying curvature radii for sections 215a, 215c and for section 215b, and/or in an analogous manner for sections 215f, 215d and for section 215e, while the internal width in between continuously increases and decreases. On the one hand, this geometric design of the core 210 gives rise to a very convenient form for the winding portions 212, 213, since, for instance by means of sections 215a, 215f, 215c, 215d, the turns of the windings to be disposed can be spatially efficiently limited. On the other hand, the curved sections lead to an avoidance of any sharp edges, wherein a desired efficient contouring of the leakage inductance portion 215 is nevertheless achieved. Thus, in a well-defined manner, leakage fluxes are induced by the optimally guiding the field within the portion 215, wherein, through the provision of the two “minimums” 210M, a highly precise coupling of the opposing portions of the core 210, and thus an optimal leakage inductance, are achieved.

In the illustrated embodiment, the total length 210L of the core 210 amounts to 20 mm or less, wherein a thickness, i.e. the dimension of the core material in a direction perpendicular to the drawing layer of FIG. 2c, amounts to around 6 mm or less. For such dimensions, inductance values for the target inductance of up to 100 mH or more can be achieved, wherein currents of some amperes may flow depending on the target inductance. On the other hand, a leakage inductance of a multiple of 100 pH can be achieved.

Thus, the core shape shown is suitable for many types of “low-power applications”, wherein the filter effect can be improved in comparison with ordinary toroidal core geometries, without significantly changing the lateral dimensions of the current-compensated inductor as compared to toroidal core geometries.

However, it should be noted that corresponding oval core shapes can also be efficiently used for power applications, in which active currents of a multiple of 10 to a multiple of 100 amperes are to be filtered with regard to differential-mode interference signals and common-mode interference signals.

FIG. 2d shows a schematic perspective view of the core 210 in accordance with the embodiment presented in FIG. 2c.

FIG. 2e schematically shows a top view of the current-compensated inductor 200, wherein the core shape shown in FIGS. 2c and 2d is used. As shown, the windings 220 and 230 are disposed on the core 210 and are connected to according terminal pins 252 of an housing or a support 250. The support 250 is adapted to the general geometrical configuration of the core 210, and is formed from any suitable material, such as plastic and the like, wherein, with high vibration requirements, additional sealing or adhesive substances may be provided within the support 250. Furthermore, the housing 250 includes a clamping device 251, which in the embodiment shown is provided in the form of clamping hooks, such that, in an appropriate manner, the device 251 can efficiently engage with the core 210, in particular at the leakage inductance portion 215. As shown, the shape of the clamping device 251 is adjusted to the generally oval shape of the core 210 such that an efficient adjustment and fixing of the housing 250 at the core 210 is simply achieved by means of adapted shapes, without the need for additional fixing materials. This type of connecting core and support has very little environmental impact. Furthermore, an inner centering region 253 is provided, which also serves as a suction surface for SMD assemblies, thus contributing to an excellent workability of the inductor 200. The mechanical fixing through the device 251 is also sufficient for enabling a sealing or adhering of the support 250 without enabling further adjustment measures between the core 210 and the core 250. In addition, terminal pins 252 are provided on the support 250 for interconnecting windings 220 and 230, respectively. The described support may also be implemented as a housing for a complete or partial sealing of the inductor.

FIG. 2f schematically shows a section view in accordance with the line IIf in FIG. 2e. As shown, the clamping hooks 251 engage with the core 210 and mechanically fix the support 250 to the core 210. Furthermore, the windings 220, 230 are disposed on the core, wherein, as previously described, this can take place by means of automated winding processes, without the necessity of a subordinated adjustment of the leakage flux, as this is the case in conventional technologies (see FIG. 1).

FIG. 3 schematically shows a graphical representation of the dependency of the inductance on the operating current for the conventional component in FIG. 1, which is to serve as a comparative object. The inductance, i.e. the inductance of the component 100 effective for the compensated operation, is plotted on the vertical axis, while the horizontal axis indicates the current. The measurement of inductance took place, at 10 kHz, with a voltage of 50 mV, wherein the temperature of the component and the surrounding area amounted to 20 degrees C. The curve A qualitatively indicates the course of the component 100 without the shunt element 140, thus the pure toroidal core strcuture, wherein a leakage inductance 330 pH arose. The use of the shunt element 140 resulted in a desired increase in the leakage inductance to 490 pH, wherein, as expected, a significant drop now occurs with higher currents for the target inductance, as this can be gathered from the curve B.

FIG. 4 schematically shows a graphical representation of the inductance depending on the forward current for the component 100 from FIG. 1 in accordance with the curve A, while the curve C indicates the corresponding behavior of the component 200 according to the invention for the embodiment shown in FIG. 2a. It should be noted that the components relating to the electrical properties are designed in the same manner, with the exception of the core geometry. However, the component 200, which is represented by the curve C, has a leakage inductance of 660 pH, which corresponds to an increase in the leakage inductance of 100% compared to a simple toroidal core arrangement of the component 100 according to the curve A. Compared to the component 100 with shunt element 140, a significant increase in the leakage inductance likewise arises, such that, in addition to the advantages in terms of the ability to manufacture, the fluctuation of the component values and the like, an overall better compensatory behavior for differential-mode interference signals is achieved.

FIG. 5 schematically shows ratios for the current-compensated inductor 200 according to the invention in accordance with an embodiment, the inductor having a core geometry, as shown in FIGS. 2c and 2d. The corresponding behavior is represented by the curve D, while the curve A in turn indicates the behavior of the conventional toroidal core component 100 without the shunt element 140. In this case, for the core according to the invention, a leakage inductance of 760 pH is determined, which corresponds to an increase of 130% compared to the pure toroidal core arrangement in accordance with the curve A.

FIG. 6 schematically shows the course of target inductance depending on the operating current for two different embodiments, i.e. the core shape, as shown in FIG. 2a (curve C), and the embodiment as essentially shown in FIGS. 2c and 2d (curve D). As can be inferred from the graphical representation, these embodiments essentially have the same qualitative behavior in terms of the target inductance, wherein both cores have a high desired leakage inductance, which is 10 to 15% higher for the core according to the curve D compared to the core of the curve C.

From the sample measurement results, which are shown in FIGS. 3 to 6, it can clearly be seen that, generally, the leakage inductance in the current-compensated inductors according to the invention can be increased compared to conventional toroidal core geometries, even if they are provided with an additional shunt element, wherein a highly efficient process for producing the current-compensated inductors can be established on the basis of the suitable core geometry. That is, the cores have a machine-capable core shape, without the necessity of additional measures, after the winding, for adjusting to a desired high level of leakage flux. The leakage flux is specified solely by the core geometry, for the indicated magnetic data and overall dimensions of the core, such that large quantities of current-compensated inductors can be produced with small area variations. The current-compensated inductors according to the invention are suitable for low-power applications in the range of 100 milliamperes to several amperes, if an efficient suppression of opposing interference signals is desired, while the interference elimination of high-performance components is also efficiently enabled on the basis of the “oval” core shape. In this case, the core shape under this invention also secures a machine-capable winding capability in conjunction with easily adjustable magnetic values, for example for the leakage flux and the like.

With reference to FIGS. 7a and 7b, embodiments of a magnetic core, along with an associated current-compensated inductor, are described therein, in which a suitable geometry for two-phase systems and particularly for multiple-phase systems, such as three-phase systems, is enabled in such a manner that, as a whole, there is a suitable suppression of common-mode interference signals and a pronounced suppression of differential-mode interference signals. A multiple-phase system is to be understood such that signals and, in particular, supply voltages and currents, take place over at least three feed lines or phases, as the case may be, in a phase-shifted manner. Thereby, the signal influx or the influx of the power supply is to take place in a manner that is as symmetrical as possible over the individual phases, wherein, however, pronounced interference signals are to be dampened by the current-compensated inductor, as this was previously described in relation to the two-phase current-compensated inductor.

FIG. 7a shows a schematic top view of a magnetic core 710, which represents a closed core shape, and can in principle be described as a toroidal core-like design, but which clearly deviates from a toroidal core shape, as this is shown as 711 with a dashed line, thus achieving a specially designed leakage inductance behavior. That is, the core 710 deviates from the toroidal core shape 711 such that a higher level of leakage inductance is brought about in the desired way, if the core 710 is used as a core for a current-compensated inductor. The desired deviation from the toroidal core shape 711 in the embodiment shown is achieved by providing, on the one hand, curved portions 713A, 7138, 713C, which gives the core 710 a design that is generally similar to a toroidal core, wherein an associated connection area is provided between two adjacent curved portions; this connection area has an appropriate design for achieving the desired overall core shape. In the example shown, three connecting portions 715A, 715B and 715C are provided, in a manner corresponding to the three curved portions 713A713A . . . 713C. Although, on a general basis, the portions 713A713A . . . 713C, along with the associated connecting portions 715A . . . 715C, are provided with a form that deviates from one another, in advantageous embodiments these areas are designed in the same manner, with the exception of deviations caused in production processes, such that, as a whole, a highly symmetrical structure arises for the core 710 and thus for the inductance ratios, in particular for the leakage inductance ratios. That is, in the embodiment shown, the core 710 is designed for a three-phase system, such that the core 710 has, on the one hand, a three-fold rotational symmetry with reference to a center M, and an axis of rotation that runs perpendicular to the drawing layer of FIG. 7a and through the center M. On the other hand, this also produces a magnetic symmetry in accordance with the geometric geometry, such that a symmetric electrical and magnetic behavior is obtained in accordance with the geometric symmetry. In the illustrated embodiment, the curved portions 713A, . . . , 713C have a distance D1 from the center M that is identical up to the manufacturing tolerances, while the connecting portions 715A . . . 715C have a distance D2 from the center M, which is different from the distance D1. In the illustrated embodiment, the connecting portions 715A . . . 715C are disposed closer to the center M than the curved portions 713A . . . 713C. That is, in this embodiment, the distance D2 is smaller than the distance D1. It should be noted that, in general, the distance of a curved portion to the center M is to be understood such that the associated distance is perpendicular to the corresponding edge line of the particular section. Since, as is self-evident, the core material of respective portions has a corresponding expansion in a direction perpendicular to the drawing layer of FIG. 7a, as this is shown in the perspective view of FIG. 2d in comparable form for the core 210, the aforementioned definition is to apply to such edge lines that arise through a cut through the core 710, which corresponds to the center plane in accordance with a line perpendicular to the drawing layer of FIG. 7a. For the sake of simplicity, it is assumed that the layer presented in FIG. 7a corresponds to this center plane.

The core 710 can also be designed for multiple-phase systems that require more than three-phases and thus windings, such that a correspondingly larger number of curved portions 713A . . . 713C and associated connecting portions 715A . . . 715C is to be provided. For example, for a four-phase system, four curved portions and four associated connecting portions are accordingly provided; for a five-phase system, five curved portions and five associated connecting portions are accordingly provided, etc. The aforementioned definition of the distances D1 and D2 gives rise to a corresponding rotational symmetry, for example a four-fold rotational symmetry, a five-fold rotational symmetry and the like. That is, in the embodiment shown, if there is a rotation by 120° around the axis of rotation through the center M, substantially the same core configuration arises again, while, with a four-fold rotational symmetry, a rotation by 90° substantially leads to the same core configuration.

This type of definition, i.e., the indication of distances of core portions to a common center, allows a deviation from the core geometry of the toroidal core shape 711 to apply to the current-compensated inductors previously described with reference to FIGS. 2a to 2f, wherein the curved portions then correspond to winding portions 212, 213, and the connecting portions then correspond to portions 215 specified as leakage inductance portion. Consequently, the corresponding rotational symmetry would be a symmetry of 180°. The distance of curved portions 212, 213 from a notional center thereby corresponds to half of the geometric length 210L, wherein the diameter and/or the maximum lateral expansion of the core material are to be substracted from this geometric length in accordance with the definition of the associated distances shown in FIG. 7a. In a similar manner, half of the internal width 210I corresponds to the distance D2 in FIG. 7a.

In the embodiment of the core 710 shown in FIG. 7a, a straight-line section 715G is also provided in the connecting portions 715A . . . 715C, which is advantageous in, for example, adjusting a corresponding magnetic total length of the core 710, without changing, for instance, the distance D2. In other embodiments, the connecting portions 715A . . . 715C may have a geometric design, as this is shown, for example, in FIG. 2c in principle for the leakage inductance portion 215 of the core 210 such that, on the one hand, the leakage inductance ratios may be suitably adjusted and, on the other hand, suitable winding portions are formed, for instance in the curved portions 713A . . . 713C. However, it should be noted that corresponding windings are not necessarily disposed on curved portions 713A . . . 713C; rather, the connecting portions 715A . . . 715C may be accordingly used as well. Thereby, it can be advantageous to provide correspondingly designed straight-line portions, for instance as schematically shown in the form of portion 715G. The leakage inductance ratios that are thereby adjusted may be recorded by simulation or with measurement technology.

FIG. 7b schematically shows a top view of a current-compensated inductors 700, in which the core 710 is provided with a three-fold rotational symmetry, i.e. a 120° symmetry, as this is suitable, for example, for a three-phase current system. For this purpose, corresponding windings are disposed on the core 710, for instance in the form of windings 720A, 720B and 720C. In the embodiment shown, the winding 720A is disposed on the curved portion 712a, the winding 720B is disposed on the curved portion 713B713B and the winding 720C is disposed on the curved portion 713C. Thus, it is at least the case that connecting portions 715A . . . 715C represent winding-free portions, which therefore have a suitable design for, on the one hand, adjusting the leakage inductance ratios, and, on the other hand, enabling a machine-capable application of the windings 720A . . . 720C, and also supporting the mechanical fixing of such windings. As previously described with reference to FIG. 7a, for this purpose the portions 715A . . . 715C may have any suitable cross-section form, wherein the cross-section may also change across the magnetic length. In the example shown, a portion is provided with a large cross-section 715Q such that it is at least the case that a corresponding protrusion of the portions 715A . . . 715C arises in the direction of the center M, which on the one hand presents a good spatial limitation of the winding spaces in the curved portions 713A . . . 713C, and on the other hand contributes to increased leakage inductance values. That is, by means of the larger cross-sections 715Q at least provided in the center of respective connecting portions 715A . . . 715C, the distances D2 are reduced such that the leakage inductance accordingly increases. The windings 720A . . . 720C may be disposed in a machine-capable manner, since the connecting portions 715A . . . 715C are particularly designed in such a manner that processing is possible by means of a winding machine through threading the wires of the windings, as this was previously described with reference to the current-compensated inductors 200. It is also the case here that the current-compensated inductor 700 can be designed for power systems with more than three phases, if correspondingly more curved portions and connecting portions are provided, as previously described. Moreover, the same properties as previously described for the windings 220, 230 of the current-compensated inductor 200 also substantially apply for the properties of the windings 720A . . . 720C. In particular, in the interactions with the magnetic properties and the geometry of the core 710, the windings may also be designed for higher currents in the range of around 10 amperes, such that properties arise that are particularly favorable for power applications in three-phase systems or multiple-phase systems. The current-compensated inductor 700 can also be provided with a suitable housing, which is mechanically fastened to the core 710, for instance through snap locks, for instance in the connecting portions 715A . . . 715C, as previously described in a similar manner for the two-phase inductor in FIG. 2e in the form of housing 250. Thus, a corresponding housing can be easily fixed and can also serve as a suction surface for vacuum gripper systems, such that the current-compensated inductor 700 can also be handled in a machine-capable manner upon the insertion of boards.

1. A current-compensated inductor, comprising:
a toroidal-shaped core without separate shunt body,
wherein for avoiding sharp edges the core comprises a first curved winding portion and a second curved winding portion and further has a leakage inductance portion disposed between the first and the second winding portion, the leakage inductance portion connecting the first winding portion and the second winding portion, so as to define a total length of the core,
wherein, a maximum core width is smaller than the total length of the core,
a first winding disposed on the first curved winding portion and
a second winding disposed on the second curved winding portion.

2. The current-compensated inductor according to claim 1, wherein the leakage inductance portion has a constant width between the first winding portion and the second winding portion.

3. The current-compensated inductor according to claim 1, wherein the width of the leakage inductance portion between the first and the second winding portion is, at least in places, smaller than the maximum core width.

4. The current-compensated inductor according to claim 3, wherein the width of the leakage inductance portion has at least two positions with minimum width.

5. The current-compensated inductor according to claim 3, wherein the core is formed from curved sections.

6. The current-compensated inductor according to claim 1, wherein a minimum internal width between opposing parts of the leakage inductance portion is equal to or larger than 50% of a maximum internal width of the core.

7. The current-compensated inductor according to claim 1, further comprising a housing or a support connected to the core by means of clamping.

8. A current-compensated inductor having a toroidal-shaped core without separate shunt body, comprising:
a core formed from curved sections for avoiding sharp edges having winding areas opposed to each other along a longitudinal direction of the core and a leakage inductance portion disposed between the winding areas in longitudinal direction, wherein the core assumes its maximum internal width outside of the center of the leakage inductance portion, and
windings, which are correspondingly disposed on the winding areas.

9. The current-compensated inductor according to claim 8, wherein an internal width at the center of the leakage inductance portion is smaller than a maximum internal width of the core.

10. The current-compensated inductor according to claim 8, wherein a minimum internal width in the leakage inductance portion is larger than or equal to 50% of a maximum internal width of the core.

11. The current-compensated inductor according to claim 8, wherein the leakage inductance portion comprises at least two places with minimum internal width.

12. The current-compensated inductor according to claim 8, wherein the core is a core without an air gap.

13. The current-compensated inductor according to claim 8, wherein a total length of the core is 20 mm or less.

14. The current-compensated inductor according to claim 8, wherein the inductor is designed for an operating current of 20 amperes.

15. The current-compensated inductor according to claim 8, further comprising a support or housing connected to the core by clamping.

16. The current-compensated inductor according to claim 1, wherein the cross-section of the core in the leakage inductance portion is smaller than or larger than the cross-section in the winding portion.

17. A current-compensated inductor having a toroidal-shaped core with a plurality of curved portions for avoiding sharp edges and without separate shunt body, comprising:
a plurality of connecting portions, wherein each connecting portion connects two of the plurality of curved portions, and
wherein the curved portions have a first distance from a common center, and the connecting portions each have a second distance from the common center, and the second distance being different from the first distance, and
wherein the common center is defined as an intersection point of distance lines, along which the first distance is measured for each curved portion and the distance lines being perpendicular to the edge lines of each curved portion, and
a plurality of windings, each of which being disposed on one of the curved portions.

18. The current-compensated inductor according to claim 17, wherein each of plurality of windings is disposed on an associated curved portion.

19. The current-compensated inductor according to claim 17, further comprising a housing connected to the core by clamping.

20. The current-compensated inductor according to claim 17, wherein three curved portions and three connecting portions are provided.

21. The current-compensated inductor according to claim 17, wherein the second distance is smaller than the first distance.

22. The current-compensated inductor according to claim 17, wherein each of the connecting portions has a straight-line section.

23. The current-compensated inductor according to claim 17, wherein the arch-shaped areas and connection areas have identical cross-sections.

24. The current-compensated inductor according to claims 17, wherein the cross-section in each of the connecting portions varies in shape and/or or area.

25. The current-compensated inductor according to claim 17, wherein the cross-section in each of the curved portions varies in shape and/or area.

26. The current-compensated inductor according to claim 17, wherein the curved portions and the connecting portions form a closed core.
